(19) United States
(12) Patent Application Publication
(10) Pub. No.: US 2015/0211877 A1
(43) Pub. Date: Jul. 30, 2015

(54) HEAD UP DISPLAY FLUIDIC LENS

(71) Applicant: BAE SYSTEMS plc, London (GB)

(72) Inventors: Leslie Charles Laycock, Chelmsford-Essex (GB); Christopher Stace, South Gloucestershire (GB)

(73) Assignee: BAE SYSTEMS plc, London (GB)

(21) Appl. No.: 14/416,549

(22) PCT Filed: Jul. 23, 2013
(86) PCT No.: PCT/GB2013/051956

§ 371 Date: Jan. 22, 2015

(30) Foreign Application Priority Data
Jul. 25, 2012 (GB) 1213227.0

(51) Int. Cl. G01C 21/36; G02B 27/01; G02B 3/14

(52) U.S. Cl. CPC G01C 21/365; G02B 3/14; G02B 27/0101; G02B 2027/013; G02B 2027/014; G02B 2027/0141; G02B 2027/0145

(57) ABSTRACT

The following invention relates to an improved lens apparatus for use in a head up display (HUD), particularly for providing a HUD with an active virtual one which has variable and selectable distance to the user. The display device for vehicles comprises, at least one display, which provides system information that is to be displayed to a user, a partially reflecting combiner, which magnifies the system information from the display, and provides an active primary virtual image of said display, at least one fluidic lens located between the at least one display and said partially reflecting combiner, to provide the active primary virtual image.

The following invention relates to an improved lens apparatus for use in a head up display (HUD), particularly for providing a primary virtual image, the apparent distance of which from the user can be actively varied.

Before the present invention is described in further detail, it is to be understood that the invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

According to a first aspect of the invention there is provided a display device for vehicles comprising,
at least one display, which provides system information that is to be displayed to a user,
a partially reflecting combiner, which magnifies the system information from the display, and provides an active primary virtual image of said display,

at least one fluidic lens located between the at least one display and said partially reflecting combiner, to provide the active primary virtual image.

The partially reflective combiner may be a stand alone device, or may be a windscreen in a vehicle vessel or craft. Projection of the image directly onto a windscreen may require specific alignment of the display to ensure that the virtual images appear in the eye line of the user. Preferably the partially reflecting combiner is a negative meniscus lens.

The user is a person or more specifically the eye-line or line of sight of the person.

The partially reflective combiner may have a thickness (ΔU) in the range of from 2 mm to 6 mm, preferably in the range of from 3 mm to 5 mm. The combiner may be selected from any material which has a high optical transmission in the visible region, typically 400-800 nm, such as, for example glass, polycarbonate or PMMA (polymethyl methacrylate), preferably the refractive index (n) is in the range of from 1.30 to 1.80, more preferably 1.45 to 1.65.

The surfaces may include one or more of a texture, coating, dye, light emitting layer, preferably an optically smooth finish.

The radius of curvature of the combiner may be in the range of from 300 mm to 1000 mm, preferably of from 400 mm to 700 mm.

The display may be located at a distance, in the range of from 1 mm to 100 mm from the fluidic lens. The fluidic lens may be located at a distance in the range of from 1 mm to 500 mm to combiner, more preferably in the range of from 100 to 300 mm. yet more preferably of from 150 mm to 250 mm. The combiner may be located at a distance, in the range of from 300 mm to 1200 m, from the user, more preferably in the range of from 700 mm to 900 mm.

The at least one display and further display may be selected from any output means such as, for example CRT, LCD, LED, OLED, projection, laser, liquid crystal on silicon (LCOS) device, such LCOS devices being illuminated by narrowband red, green and blue LED sources.

The combiner may comprise an anti reflective coating, which may be selected from any spectrally active coating or multiple thin films and may comprise, such as, for example broad or narrow band filters, comprising dyes, reflective notch films, such as, for example rugate thin films, diffraction gratings, as known in the art. Typical antireflective coatings may consist of alternating high (2.0-2.5) and low (1.38-1.46) refractive index layers of dielectric materials. Typical high index materials include Ta₂O₅, TiO₂, Nb₂O₅, ZrO₂ and SiN, and low index materials mainly SiO₂ and MgF₂. The coatings may be deposited to provide layers of quarter-wave (QW) thickness. The broader the band covered, generally the more layers are required in the coating applied to the surface.

The fluidic lens provides a variable focus lens, which can be operated to alter the apparent distance of the active primary virtual image from the user. The power of the fluidic lens is variable and may lie in the range of from 3 to 10, more preferably 4 to 7.

The fluidic lens may comprise an optically transparent cavity and a transparent liquid contained within the cavity by an optically transparent flexible membrane whose surface profile (and hence the focal length of the fluidic lens) may be varied by controllably deforming the lens to afford said change in focal length.

The fluidic lens may be caused to change its focal length by a number of means. This may be achieved by applying a variable pressure to the liquid within the cavity. Alternatively, the shape of the cavity may be changed by the use of an optically transparent piezoelectric element which forms at least one wall of a fluidic lens cavity so that the optical properties of the fluidic lens may be varied by energising selected portions of the piezoelectric element to thereby change the shape of the cavity.

The fluidic lens has very few mechanical moving parts. Therefore changes in the focal length are easily achieved without the use of mechanical movement, i.e. servo motors to physically move conventional mirrors or lens' to change the distance between said mirror and/or lens and the display, or with respect to the combiner. The fluidic lens is hence very compact and robust compared to mechanical systems.

The active virtual image may be preferably projected at a distance (V) in the range of from 500 mm to 100 m, such that the virtual image appears outside the vehicle, and is able to be placed at a position which coincides with an actual feature in the landscape viewed through a windscreen. The landscape may be any terrain, ocean or even the sky, and the feature is some recognisable aspect of the landscape. The feature may be part of a road network, such as a turning, junction, local hazards or it may be routes pathways across off-road terrains, to provide guidance to preferred pathways or routes to avoid hazards.

The fluidic lens provides a variable focus lens, which can be operated to alter the apparent distance of the active primary virtual image from the user. The system information is projected from the at least one display via the combiner to provide the variable distance active primary virtual image. The virtual image may have its distance from the combiner selected, depending on the system information being provided. The fluidic lens allows the active primary virtual image to be located at the correct distance with respect to the user, such that the active primary virtual image actually appears to be located at a point of interest, even up to 50 or 100 metres away. If the display merely provided a smaller primary virtual image without a fluidic lens (to give the illusion of depth), said image would appear at a fixed distance from the user, and hence a human's binocular vision would not be able to process the virtual image with the actual scene, when viewed through the windscreen. The fluidic lens allows the active primary virtual image to actively track a particular feature, road marking etc in real time, so as to provide real time direction to the user.

In a highly preferred arrangement the active primary virtual image is an indicator such as for example an arrow, pointer, marker, indicative character. In a highly preferred arrangement the indicator is part of a navigation system that moves in three dimensions within the user's field of view, to project and provide an indicator which appears to point or direct on the actual road ahead, rather than within the confines of a projected data map. Optionally there may be provided a data generated map provided by a second display via the beam splitter, which additionally provides a second virtual image which overlays the actual terrain, road network.

In use the apparent distance of the indicator from the user is able to move such that the indicator can point to a correct junction, turning or to a generally preferred direction to be taken. The indicator may also change in appearance such as any aesthetic change, such as for example, size, shape, transparency or colour depending on the relative position of the vehicle, vessel or craft to said junction, direction or turning.

The display device may comprise a second display which is optically linked via a beam splitter, such that both the primary and secondary displays both project via the beam splitter. Therefore the beam splitter allows projection of a second image via the partially reflective combiner to provide a secondary virtual image. The secondary virtual image is preferably provided at a fixed distance from the user. The secondary virtual image may display further data from the system information, which may relate to navigation or other in-vehicle systems, such as, for example to provide current speed, speed limits, hazards, junction information, or any supplementary information, which can be easily viewed. In a further embodiment, the secondary display may also have a fluidic lens located between the display and the beam splitter, to provide an active secondary virtual image. Further displays or information systems are envisaged.

The at least one display and second display may provide an output from the at least one system information, such as for example the vehicles original on board display panel (i.e. dashboard), an OEM or add-on entertainment system, navigation system or communication system. It may be desirable as a retro fit option, to provide a virtual image of the existing vehicle dashboard by using a video camera to capture real time output from the vehicle dashboard and so provide an image on the display panel, and hence to provide a virtual image via the partially reflective combiner. It may be desirable to provide further information from an external source i.e. traffic information or system information from at least two system information sources, the system information may then be overlaid or provided as two discrete messages, typically a warning secondary virtual image.

In a preferred arrangement the separation between the two virtual images ΔV, may be selected in the region of 30 mm to 100 m. This provides an active primary virtual image and a secondary virtual image, wherein the latter is significantly closer to the user, and hence may serve to provide system information which is of greater importance, such as, for example, a warning message, failure of a component, hazard detection, road information, speed, name of a junction or turning etc.

It may be desirable to provide the warning secondary virtual image in a colour which visually contrasts with the active primary virtual image.

The indicator is able to continuously move and map the feature of the landscape with the continued movement of the vehicle. This is achieved by the display device changing the focal length of the fluidic lens thereby altering the distance of the virtual image from the user.

According to a further aspect of the invention there is provided a method of providing navigation to a user of a vehicle in a landscape, comprising displaying an image from a display device as defined herein, from the vehicles system information, of at least one indicator in a head-up display of said vehicle, said indicator being superimposed as a virtual image over a feature in said landscape to provide direction to the user, in such a way that the indicator appears to a user of the virtual image of the indicator from within the vehicle to be a real object existing at said feature in the landscape, wherein a fluidic lens within said display device provides the indicator at the same distance as said feature.

There is further provided a method for determining a route for the vehicle, computing data that controls the head-up display in such a way that the indicator appears to the user to be located at a feature on the landscape, and repeating the computing at successive time intervals in such a way that the indicator appears to the observer to be substantially stationary relative to the feature in the landscape even when the vehicle is moving.

In a preferred method of use the indicator changes in appearance as the vehicle approaches the feature in the landscape.

An embodiment of the invention will now be described by way of example only and with reference to the accompanying drawings of which:

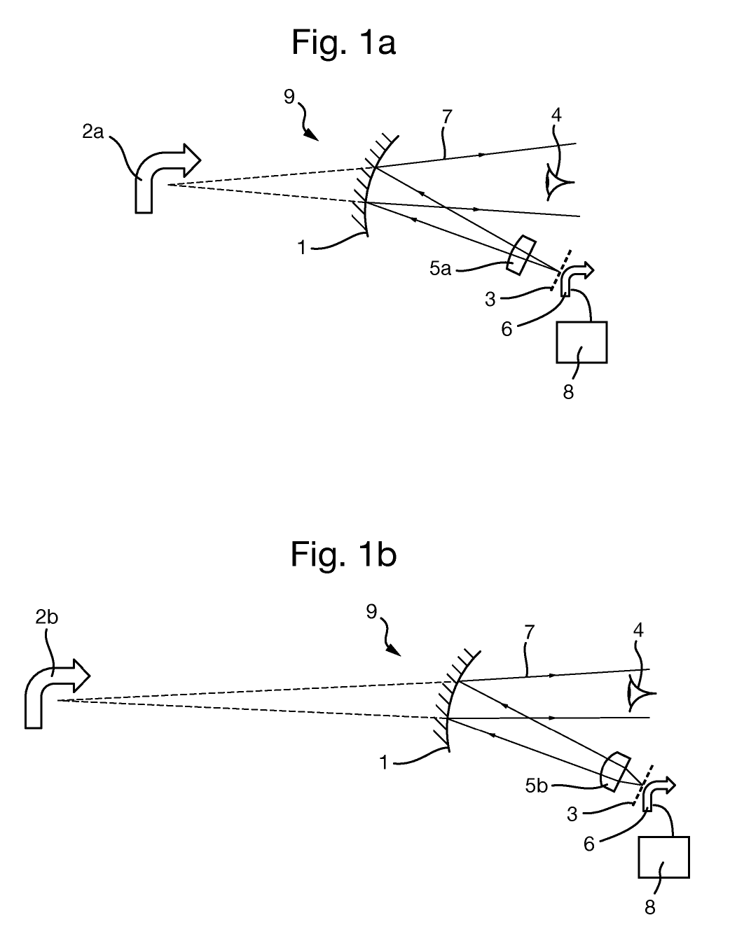

FIG. 1a and 1b show a head up display schematic for a vehicle

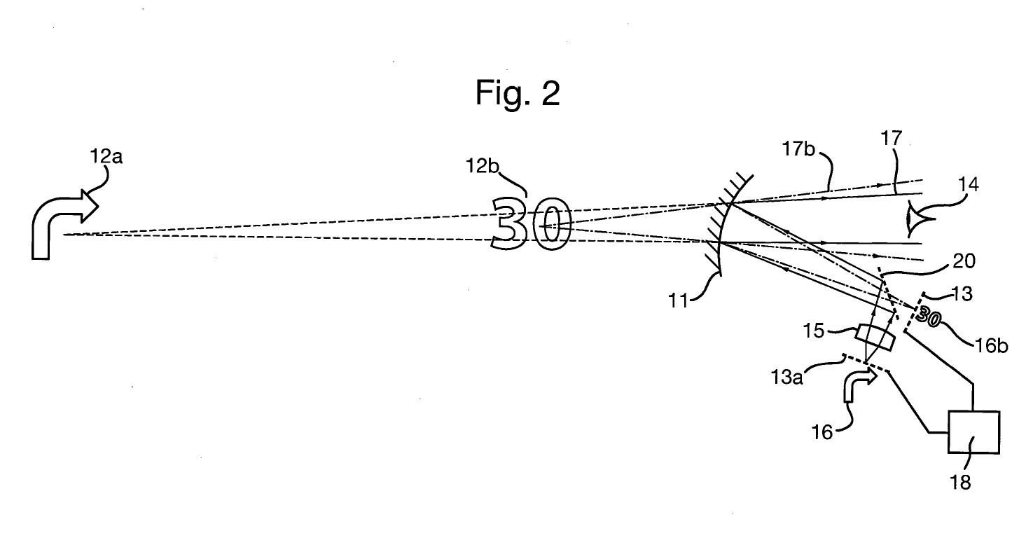

FIG. 2 shows a head up display with two displays

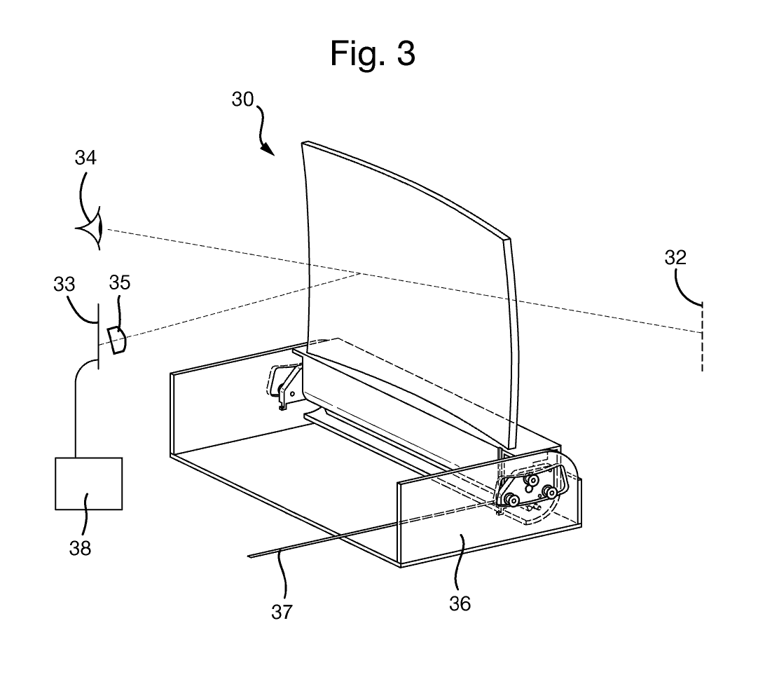

FIG. 3 shows a head up display device in a deployment device

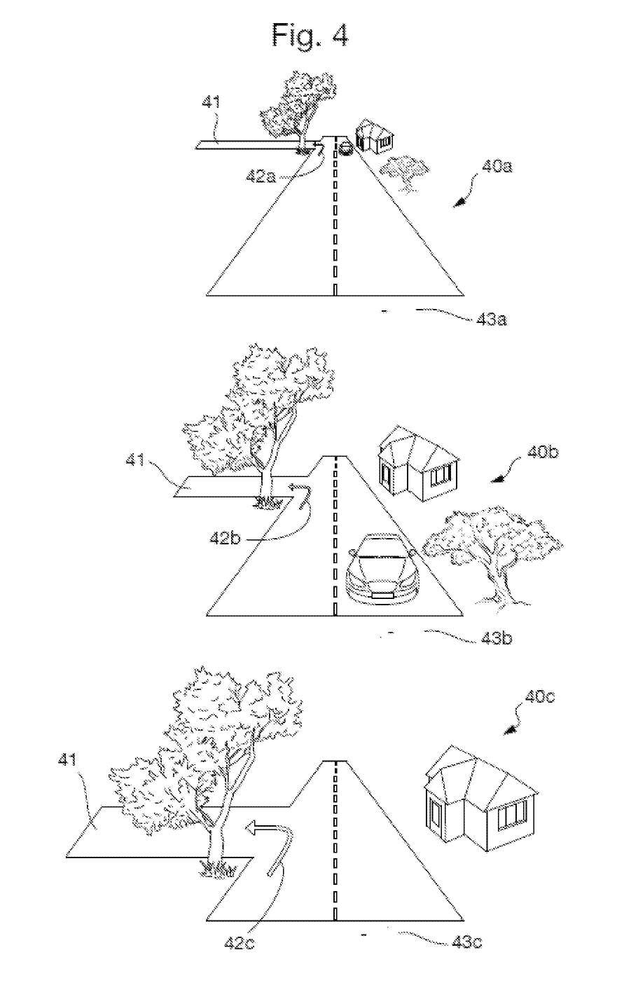

FIG. 4 shows a schematic of a virtual image overlaid on an urban landscape.

Turning to FIG. 1a, there is provided a display device 9, comprising a display 3, which provides an active virtual image 2a to be displayed in the line of sight 7, of the user 4. The display 3 outputs an image 6 from the vehicle information system 8, such as, for example, a car dashboard, satellite navigation, or an entertainment system.

The display 3 projects the image 6 via a fluidic lens 5a, set to a first level of magnification, which is then directed to a partially reflective combiner(or windscreen) 1, which provides an active virtual image 2a, remote from the user 4, outside of the vehicle (not shown).

The use of a partially reflective combiner 1, may remove the requirement of using a vehicle windscreen as the partially reflective surface, and thus allows the display device 9 to be readily retrofitted to any vehicle, without prior consideration of the optical properties of the vehicle windscreen.

FIG. 1 b shows the fluidic lens 5b, altered to a second magnification, which allows the image 6, to be projected as an active virtual image 2b, which appears to the user 4 to be at a different distance compared to active virtual image 2a.

FIG. 2 provides a ray diagram for the use of two displays 13a, 13b, from the vehicle information system 18. The primary display 13a, provides the active virtual image 12a, nominally in the shape of an arrow. The display 13a generates image 16a, from the vehicle information system, which is projected via a fluidic lens 15 to provide an active or controlled magnification, the light then passes via a beam splitter 20, which directs the light to the windscreen 11 of a vehicle (not shown), to form the active virtual image 12a. The active virtual image 12a may be moved along the eye line 17a of the user 14, such that it appears at different distances to said user 14 (as shown in FIG. 1). The information system 8 may provide a second image 16b, nominally the vehicles speed or a road name, this image is passed via the beam splitter 20 and windscreen 11, to provide a fixed focal length virtual image 12b, which appears to remain fixed in the user's 14 eye line 17b.

In FIG. 3 there is provided a HUD system 30 comprising a combiner 31 in a deployment housing 36. The combiner may be deployed to the active position as shown when in use, such that the user 34, is able to view a virtual image 32, which is caused by the display 33, projecting an image of the data from the vehicle information system 38, via the fluidic lens 35 on to the combiner. A draw cord 37 may be activated by a servomotor, to raise and lower the combiner 31. In the inactive position the combiner lies in a position which is substantially orthogonal to that shown.

FIG. 4 shows three time frames of a schematic representation of an actual road layout 40a-c. The user (driver of a vehicle not shown), would through their windscreen see a road layout 40a ahead, the vehicle information system (satellite navigation) would provide an arrow 42a as a virtual image, as described in relation to FIG. 2, which overlays the preprogramed and desired junction 41a. At the same time the information system may display a secondary virtual image 43a such as location information, distance to the junction or the junction name.

As the vehicle approaches the junction 41 the size of the virtual image arrow 42b, increases and additionally moves closer to the user, concomitantly the location information 43b, is updates to tell the driver the distance between the vehicle and the junction. The arrow 42b, is able to continuously move and map the movement of the vehicle, by the display device constantly altering the focal length of the fluidic lens.

As the vehicle is on the final approach to the junction 41, the arrow 42c, again increases in size, there may be other indicators such as colour changes, change in transparency, or other aesthetic changes, which alert the driver that it is the junction which is to be taken; concomitantly the location information 43b, updates to tell the driver the distance between the vehicle and the junction.

The system may prove exceptionally beneficial where there are complex road layouts, where there are multiple lanes and turnings, such that the overlay of direction information, by use of a virtual image directly onto the actual road network, provides clear and unambiguous direction, without the need to look at a computer generated map, which is often out of the eye line of the user.

1. A display device for vehicles comprising:
at least one display, which provides system information that is to be displayed to a user;
a partially reflecting combiner, which magnifies the system information from the display, and provides an active primary virtual image of said display; and
at least one fluidic lens located between the at least one display and said partially reflecting combiner, to provide the active primary virtual image.

2. A display device according to claim 1 wherein the partially reflecting combiner is a negative meniscus lens.

3. A display device according to claim 1, further comprising:
a beam splitter located between the fluidic lens and the partially reflective combiner and
a second display, that provides a secondary virtual image.

4. A display device according to claim 3, further comprising a further fluidic lens located between the second display and said beam splitter, to provide an active secondary virtual image.

5. A display device according to claim 3 wherein the secondary virtual image is selected to provide warning or danger information which appears in front of the active primary virtual image.

6. A display device according to claim 3 wherein the secondary virtual image and active primary virtual image are separated by a distance in the range of from 200 mm to 600 mm.

7. A display device according to claim 1 wherein the display includes a liquid crystal on silicon (LCOS) device, illuminated by narrowband red, green and blue LED sources.

8. A method of providing navigation to a user of a vehicle in a landscape, the method comprising:
displaying, from a display device, an image of at least one indicator in a head-up display of said vehicle, the image generated from system information of the vehicle, said indicator being superimposed as a virtual image over a feature in said landscape to provide direction to the user, in such a way that the indicator appears to be a real object existing at said feature in the landscape, wherein a fluidic lens within said display device provides the indicator at the same distance as said feature.

9. A method according to claim 8 further comprising:
determining a route for the vehicle;
computing data that controls the head-up display in such a way that the indicator appears to the user to be located at a feature on the landscape; and
repeating the computing at successive time intervals in such a way that the indicator appears to the user to be substantially stationary relative to the feature in the landscape even when the vehicle is moving.

10. A method according to claim 9, wherein the indicator changes in appearance as the vehicle approaches the feature in the landscape.

11. A method according to claim 8, wherein the indicator changes in appearance as the vehicle approaches the feature in the landscape.

12. A method according to claim 8, further comprising:
providing, via a second display optically linked via a beam splitter to the first display device, a secondary virtual image.

13. A method according to claim 12, wherein the secondary virtual image is selected to provide warning or danger information.

14. A method according to claim 8, further comprising:
providing, via a second display optically linked via a beam splitter to the first display device and a further fluidic lens located between the second display and said beam splitter, an active secondary virtual image.

15. A method according to claim 8 wherein the display device includes a liquid crystal on silicon (LCOS) device, illuminated by narrowband red, green and blue LED sources.
